(19) United States
(12) Patent Application Publication
(10) Pub. No.: US 2024/0124129 A1
(43) Pub. Date: Apr. 18, 2024

(54) AIRCRAFT HAND CONTROLS

(71) Applicant: AVIAN AEROSPACE LLC, Mansfield, OH (US)

(72) Inventors: Clayton Prescan SMELTZ, Mansfield, OH (US); Buddy Prescan SMELTZ, Aliquippa, PA (US)

(73) Assignee: AVIAN AEROSPACE LLC, Mansfield, OH (US)

(21) Appl. No.: 18/218,573

(22) Filed: Jul. 5, 2023

Related U.S. Application Data
(63) Continuation of application No. PCT/US2023/010069, filed on Jan. 3, 2023.
(60) Provisional application No. 63/436,694, filed on Jan. 2, 2023.
(60) Provisional application No. 63/296,154, filed on Jan. 3, 2022.
(60) Provisional application No. 63/296,155, filed on Jan. 3, 2022.

(30) Foreign Application Priority Data
Jan. 3, 2023 (WO) PCT/US2023/010069

(51) Int. Cl. B64C 13/04

(52) U.S. Cl. CPC B64C 13/0421; B64C 13/044

(57) ABSTRACT

Provided is an aircraft hand controls. The aircraft hand controls may comprise a set of left and right brake hand controls and a rudder hand control. The set of left and right brake hand controls may be operatively connected to the rudder pedals or toe brakes. The set of left and right brake hand controls may also comprise a hydraulic brake adaptation for plumbing hydraulic pressure into the aircraft's hydraulic brake system. The aircraft hand controls may comprise one or more push-to-talk buttons.

### CROSS-REFERENCE TO RELATED APPLICATIONS

This application claims priority to U.S. Provisional Patent Application Nos. 63/296,154 and 63/296,155 entitled “AIRCRAFT HAND CONTROLS,” filed on Jan. 3, 2022, U.S. Provisional Patent Application No. 63/436,694 entitled “AIRCRAFT HAND CONTROLS,” filed on Jan. 2, 2023, and PCT Application No. PCT/US2023/010069 entitled, “AIRCRAFT HAND CONTROLS,” filed Jan. 3, 2023, all of which are incorporated herein by reference in their entireties.

### TECHNICAL FIELD

The subject disclosure relates generally to aircraft hand controls, and more particularly to aircraft hand controls for controlling the rudder and brakes by hands.

### BACKGROUND

Aircraft require inputs from the pilot in order to operate the aircraft. Most aircraft require inputs from the feet, such as through the rudder pedals and toe brakes, to operate the aircraft. Therefore, a need exists to make an aircraft and aircraft hand controls as an adaptive device that is easy to use without requiring inputs from the feet.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an aircraft hand controls adapted to connect to and control the rudder and brakes of an aircraft. The aircraft hand controls may comprise a left brake hand control, a right brake hand control, and a rudder hand control. The left brake hand control and the right brake hand control may comprise a brake lever, a brake push rod, and a brake arm. The length of the brake lever may be greater than a length of the brake arm and the brake push rod combined. The brake lever, the brake push rod, and the brake arm may be joined by a connection mechanism that may rotate or pivot. The rudder hand control may comprise a lever arm that angle out on a horizontal direction.

The brake hand controls may have a hydraulic brake adaptation, wherein a set of hydraulic master cylinders may convert exerted pressure from the brake hand controls into hydraulic pressure. The set of hydraulic master cylinders may plumb the hydraulic pressure into a right hydraulic brake or a left hydraulic brake based on whether the exerted pressure comes from a left brake hand control or a right brake hand control.

The aircraft hand controls may also comprise a push-to-talk feature, wherein one or more push-to-talk buttons may turn on a push-to-talk feature connected to an audio panel. The one or more push-to-talk buttons may be on a left brake hand control, a right brake hand control, or a rudder hand control. The one or more push-to-talk buttons may be located on a left brake lever handle of the left brake hand control, a right brake lever handle of the right brake hand control, or a rudder grip of the rudder hand control.

### DESCRIPTION OF THE DRAWINGS

The subject disclosure may be better understood by reference to the following detailed description taken in connection with the following illustrations, wherein:

FIG. 1 is a left perspective view of the aircraft hand controls in accordance with various disclosed aspects herein;

FIG. 2 is a right perspective view of the aircraft hand controls in accordance with various disclosed aspects herein;

FIG. 3 is a front view of the aircraft hand controls in accordance with various disclosed aspects herein;

FIG. 4 is a left view of the aircraft hand controls in accordance with various disclosed aspects herein; and

FIG. 5 is a right view of the aircraft hand controls in accordance with various disclosed aspects herein;

FIG. 6 is an explosive view of a brake arm in accordance with various disclosed aspects herein;

FIG. 7 is an explosive view of a brake push lever in accordance with various disclosed aspects herein;

FIG. 8 is an explosive view of a rudder hand control in accordance with various disclosed aspects herein;

FIG. 9 is a southeast isometric view of the aircraft hand controls in accordance with various disclosed aspects herein;

FIG. 10 is a southwest isometric view of the aircraft hand controls in accordance with various disclosed aspects herein;

FIG. 11 illustrates an example, non-limiting, embodiment of the aircraft hand controls comprising push-to-talk buttons in accordance with various disclosed aspects herein;

FIGS. 12-13 illustrate an example, non-limiting, attachment variation for the aircraft hand controls comprising a quick release mechanism in accordance with various disclosed aspects herein;

FIGS. 14-15 illustrate an example, non-limiting, hydraulic brake adaptation for the aircraft hand controls in accordance with various disclosed aspects herein;

FIGS. 17-18 illustrate another example, non-limiting, attachment variation for the aircraft hand controls comprising rudder pedal attachment plates in accordance with various disclosed aspects herein;

FIGS. 19-20 illustrate an aircraft having the aircraft hand controls in accordance with various disclosed aspects herein; and

FIGS. 21-22 illustrate a left brake grip and right brake grip of an aircraft having aircraft hand controls in accordance with various disclosed aspects herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to embodiments of the subject disclosure, examples of which are illustrated in the accompanying drawings. It is to be understood that other embodiments may be utilized, and structural and functional changes may be made without departing from the scope of the subject disclosure. Moreover, features of the embodiments may be combined, switched, or altered without departing from the scope of the subject disclosure, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the subject disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Aircraft are designed to generate lift. The cross-sectional shape of the wing is an airfoil designed to reduce drag and generate lift. Other adjustable areas on an aircraft are flight control surfaces. The three primary flight control surfaces are the aileron, elevator, and rudder. Changes in these aerodynamic devices affect lift and drag produced by the airfoil and flight control surfaces, which allow the pilot to control the aircraft's three axes of rotation.

The ailerons are attached to the outboard trailing edge of the wings and control the roll about the longitudinal axis. The ailerons on the wings move in opposite directions from one another. An upward deflection on one wing causes it to decrease camber resulting in decreased lift while a downward deflection on another wing causes it to increase camber resulting in increased lift. Thus, increasing lift on one wing while decreasing lift on another causes the aircraft to roll in the direction of the wing with decreased lift. These movements are made through the control wheel or control stick.

The elevators are attached to the trailing edge of the horizontal stabilizer and control the pitch about the lateral axis. On most aircrafts the elevators on either side of the tail move symmetrically. A forward movement of the control column or control stick deflects the elevators downwards and an aft movement deflects upwards. An upward elevator deflection decreases camber and causes the tail to have a downward aerodynamic force. As a result the nose pitches up. A downward elevator deflection lifts the tail and pitches the nose down.

The rudder is attached to the trailing edge of the vertical stabilizer and control the yaw about the vertical axis. The rudder is controlled by the left and right rudder pedals connected to the left and right rudder posts, respectively. Pushing the left rudder pedal forward moves the rudder to the left causing an aerodynamic force to the right, which shifts the tail of the aircraft to the right and yaws the nose of the aircraft to the left. Pushing the right rudder pedal forward moves the rudder to the right causing an aerodynamic force to the left, which shifts the tail of the aircraft to the left and yaws the nose of the aircraft to the right. The effectiveness of the rudder increases with speed. The left and right rudder pedals also have toe brakes for controlling the left and right brakes by pushing the toe brakes on the rudder pedals forward. The left toe brake controls the left brake and the right toe brake control the right brake. By applying the left brake and the right brake independently, the differential braking allows the pilot to more effectively steer the aircraft while operating on the ground, such as during taxiing, takeoff, and landing. Differential braking is often also called differential steering when used to steer the aircraft 900.

As is shown below, flying an aircraft especially during takeoff and landing requires a pilot to at least be able to simultaneously control the yoke or sidestick, the thrust lever, the left and right rudder pedals, the left and right toe brakes, and still be able to hold down the push-to-talk (PTT) switch to communicate with air traffic controller (ATC). Aspiring pilots needing to use an adaptive device to fly usually do not own their own aircraft to make modification before learning to fly through flight schools.

Embodiments disclosed herein relate to an aircraft hand controls as an adaptive device for controlling the rudder and brakes by hands and provide one or more additional push-to-talk (PTT) switches connected to the aircraft's audio panel. The aircraft hand controls may be operatively connected to the rudder pedals and/or the rudder posts on the pilot side or the copilot side. The aircraft hand controls may comprise a left brake hand control for controlling the left brake and a right brake hand control for controlling the right brake. The aircraft hand controls is designed so that its function does not render an existing aircraft's function inoperative. For example, the rudder pedals and toe brakes may still be accessible for controlling the rudder and brakes in the existence of an installed aircraft hand controls. The aircraft hand controls may be installed and removed from an aircraft without modifications to the aircraft.

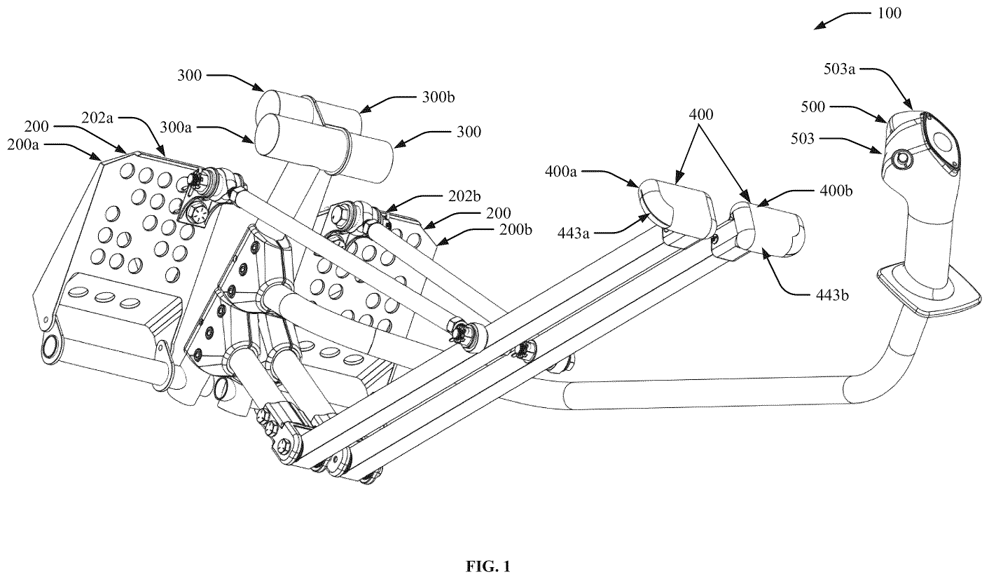

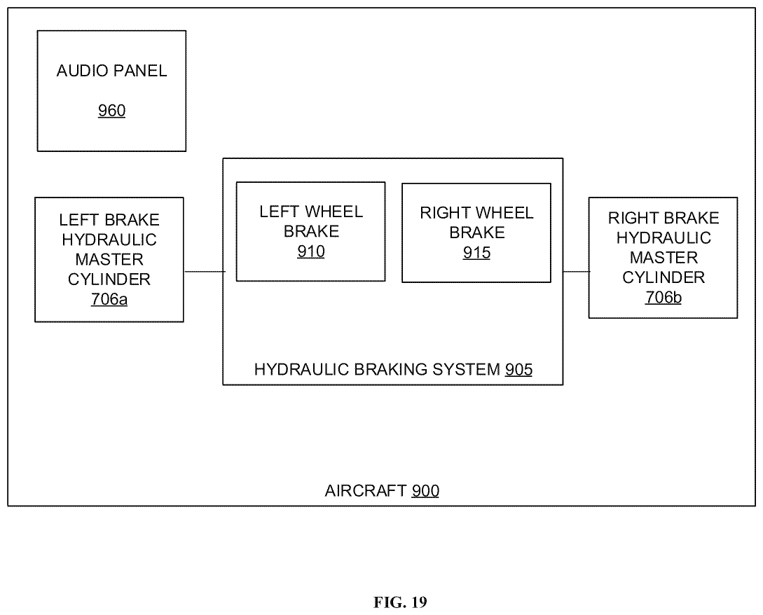

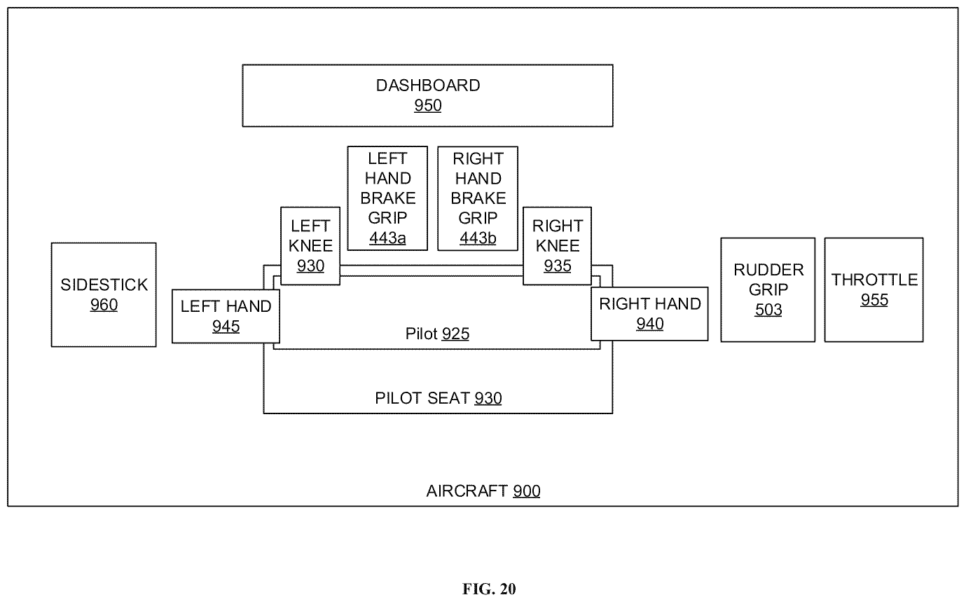

FIG. 1 illustrates a left perspective view of an aircraft hand controls 100 operatively connected to rudder pedals 200 and rudder posts 300 for controlling the rudder and brakes of an aircraft 900. FIGS. 19-20 are block diagrams of aircraft having aircraft hand controls 100. The rudder pedals 200 may be linked to the rudder posts 300 in a way that input on the rudder pedals 200 is the same as input on the rudder posts 300. For example, a push on the left rudder pedal 200a may be the same as a push on the left rudder post 300a, and a push on the right rudder pedal 200b may be the same as a push on the right rudder post 300b.

The aircraft hand controls 100 may comprise brake hand controls 400, which may include a left brake hand control 400a and a right hand brake 400b, and a rudder hand control 500. The left brake hand control 400a may be operatively connected to the left rudder toe brake 202a on the left rudder pedal 200a, and the left brake hand control 400a may be clamped onto the left rudder post 300a. The right brake hand control 400b may be operatively connected to the right rudder toe brake 202b on the right rudder pedal 200b, and the right brake hand control 400b may be clamped onto the right rudder post 300b.

A push forward toward the dashboard 950 of aircraft 900 on the handle (grip) 443a of the left brake hand control 400a may push the left rudder toe brake 202a forward and apply the left wheel brake 910 of aircraft 900. While a push forward toward the dashboard 950 of aircraft 900 on the handle (grip) 443b of the right brake hand control 400b may push the right rudder toe brake 202b forward and apply the right wheel brake 910 of aircraft 900. A push forward toward the dashboard 950 of aircraft 900 on both of the grip 443a of left hand brake 400a and the grip 443b of right hand brake 400b applies both left wheel brake 910 and right wheel brake 915 of aircraft 900. As can be seen, the left brake grip 443a and right brake grip 443b are operatively connected to the hydraulic braking system 905 of aircraft 900 without making any changes to the systems of aircraft 900. A push forward of the left brake grip 443a toward the dashboard 950 pushes the left rudder toe brake 202a. Pushing the left rudder toe brake 202a applies the left wheel brake 910 through the hydraulic braking system 905 of aircraft 900. Similarly, a push forward of the right brake grip 443b toward the dashboard 950 pushes the right rudder toe brake 202b. Pushing the right rudder toe brake 202b applies the right wheel brake 915 through the hydraulic braking system 905 of aircraft 900.

As can be seen, a pilot of aircraft 900 can apply a first level of input force to the left brake hand control 400a and a second level of input force to the right brake hand control 400b through left hand brake grip 443a and right hand brake grip 443b. In some instances, the first and second level of input force are the same, such as when the pilot wishes to deploy full braking to slow down the aircraft immediately upon landing or spooling up the engine to the desired RPM at takeoff. Other times, the first level of input force and second level of input force can differ, such as when the pilot wishes to apply differential braking when taxiing or steering the aircraft down the runway during takeoff or landing, The pilot 925 can apply differential braking by applying input force to the left hand brake grip 443a using the left hand 945 and input force to the right hand brake grip 443b using right hand 940. Applying a higher level of input force moves the hand brake handle closer to the dashboard 950. Further, moving the hand brake handle closer to the dashboard 950 results in a higher level of braking force being applied by the corresponding wheel brake of the hydraulic braking system 905. For example, the hydraulic braking system 905 applies a higher level of braking to the left wheel brake 910 the closer the pilot 925 moves the left hand brake grip 443a away from the pilot seat 930 and toward the dashboard 950. Similarly, the hydraulic braking system 905 applies a higher level of braking to the right wheel brake 915 the closer the pilot 925 moves the right hand brake grip 443b away from the pilot seat 930 and toward the dashboard 950.

The pilot 925 can also apply differential braking by applying different input forces to the left hand brake grip 443a and right hand brake grip 443b by grasping with a single hand, either left hand 945 or right hand 940, both of the left hand brake grip 443a and right hand brake grip 443b and rotating the wrist of the single hand such that one of the left hand brake grip 443a or right hand brake grip 443b is moved closer to the dashboard 950. For example, when the wrist of left hand 945 is rotated such that the left hand brake grip 443a is closer to the dashboard 950 and the right hand brake grip 443b is closer to the pilot seat 930, then a higher level of braking force is being applied by the left wheel brake 910, when compared to the braking force being applied by the right wheel brake 915. This will cause the aircraft 900 to steer to the left.

Similarly, when the wrist of right hand 940 is rotated such that the right hand brake grip 443b is closer to the dashboard 950 and the left hand brake grip 443a is closer to the pilot seat 930, then a higher level of braking force is being applied by the right wheel brake 915, when compared to the braking force being applied by the right wheel brake 910. This will cause the aircraft 900 to steer to the right.

In an exemplary embodiment of aircraft hand controls 100, the left hand brake grip 443b and right hand brake grip 443b are located between the pilot seat 930 and dashboard 950 and are situated between the left knee 930 and right knee 935 of the pilot 925 (the left hand brake grip 443b and right hand brake grip 443b can be situated between the left thigh and right thigh of taller pilots 925, or located in front of the pilots left knee 930 and right knee 935 of shorter pilots 925). The brakes are fully deployed when the left hand brake grip 443a and right hand brake grip 443b are moved toward the dashboard 950 in the horizontal direction (moved in the same plane as floorboard 960 of aircraft 900) to the end of their full range of motion. In the exemplary embodiment, the left hand brake grip 443a and right hand brake grip 443b can each travel away from the pilot seat 930 and toward the dashboard 950 about 4.5-5.5 inches (full range of motion), with 0 inches being the position of the left hand brake grip 443a and right hand brake grip 443b when they are closest to the pilot seat (and when no braking force is being applied). In other embodiments, the left hand brake grip 443a and right hand brake grip 443b can each travel away from the pilot seat 930 and toward the dashboard 950 about 5 inches (full range of motion). In further embodiments, the left hand brake grip 443a and right hand brake grip 443b can each travel away from the pilot seat 930 and toward the dashboard 950 about 4-6 inches (full range of motion). In other embodiments, the left hand brake grip 443a and right hand brake grip 443b can each travel away from the pilot seat 930 and toward the dashboard 950 about 3-7 inches (full range of motion). In other embodiments, other ranges of motion can be selected based on the space between the pilot seat 930 and dashboard 950. Further, in some embodiments, the amount of input force into each of the left hand brake grip 443a and right hand brake grip 443b by the pilot 925 to apply the respective left wheel brake 910 and right wheel brake 915 can be between about 5-10 pounds.

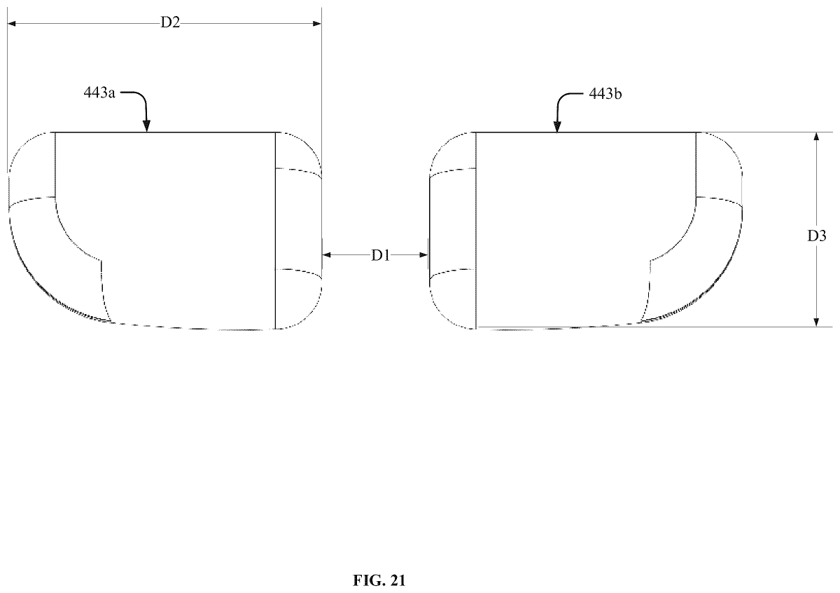

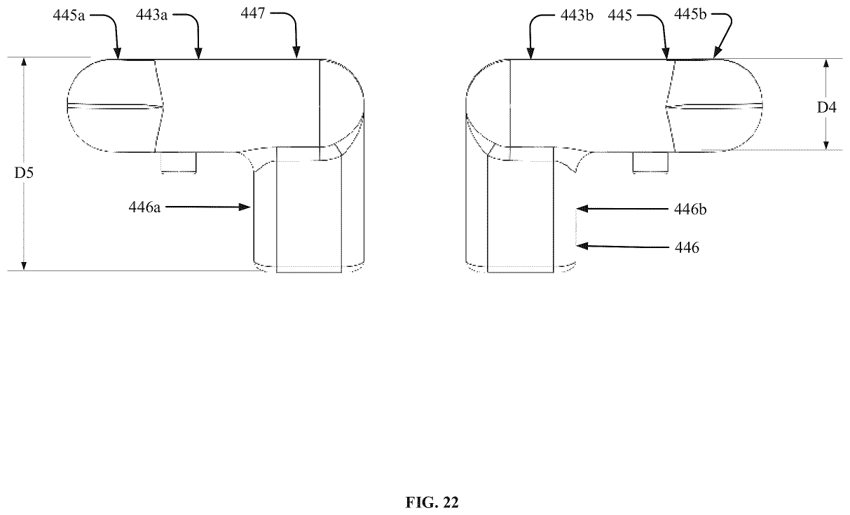

Turning to FIGS. 21 and 22, the hand brake grips 443 have an upper portion 445 and a lower portion 446 and a top portion 447. The left hand brake grip 443a and right hand brake grip 443b are spaced apart and shaped such that a pilot can easily hold and apply different forces simultaneously to each of the hand brake grips 443 using a single hand, such as by twisting the wrist of the hand that is holding both of the hand brake grips 443. In an embodiment, the left hand brake grip 443a is spaced apart from the right hand brake grip 443b by about a first distance of D1 inches. In an embodiment D1 can be about 0.93 inches. However, it is contemplated that in some embodiments, D1 can be between about 0.5 inches and 1.5 inches. Further, each of the left hand brake grip 443a and right hand brake grip 443b is about a second distance of D2 inches wide. In an embodiment, D2 can be about 2.7 inches. However, it is contemplated that in some embodiments, D2 can be between about 2 inches and 3.5 inches.

Additionally, each of the left hand brake grip 443a and right hand brake grip 443b is about a first distance of D3 inches deep. In an embodiment, D3 can be about 1.48 inches. However, it is contemplated that in some embodiments, D3 can be between about 1.25 inches and 2 inches. Further, each of the left hand brake grip 443a and right hand brake grip 443b has a top portion 445, 445a, 445b that the hand of the pilot 925 grasps that is about a third distance of D4 inches tall. In an embodiment, D4 can be about 0.42 inches. However, it is contemplated that in some embodiments, D4 can be between about 0.25 inches and 1 inch. Further, each of the left hand brake grip 443a and right hand brake grip 443b has a lower portion 446, 446a, 446b. The total height of each of the left hand brake grip 443a and right hand brake grip 443b, which includes both the top portion 445 and the lower portion 446, is about a fifth distance of D5 inches tall. In an embodiment, D5 can be about 0.65 inches. However, it is contemplated that in some embodiments, D5 can be between 0.5 and 1.5 inches. Further, in an embodiment, the top 447 of each of the left hand brake grip 443a and right hand brake grip 443b can be about a sixth distance D6 from the floorboard 960 of the aircraft 900 when the brakes are not applied. In an embodiment, D6 can be about 23.5 inches. However, it is contemplated that in some embodiments, D6 can be between 20 and 28 inches. Further, it is contemplated that D1-D6 can be any dimension that would permit a pilot to grasp left hand brake grip 443a and right hand brake grip 443b with a single hand and simultaneously manipulate both brake grips 443a and 443b to perform differential braking of aircraft 900 with a single hand.

The rudder hand control 500 may be operatively connected to the left rudder post 300a or the right rudder post 300b. In FIG. 1, the rudder hand control 500 is illustrated as being clamped onto the left rudder post 300a, so movements made with the rudder hand control 500 may move the left rudder post 300a. As shown in FIG. 1, the rudder hand control 500 may angle out in the horizontal direction, so a pushing motion on one end of the rudder hand control 500 may create a pulling action on the other end and a pulling motion on one end of the rudder hand control 500 may create a pushing action on the other end.

Accordingly, pushing downward on the rudder grip 503 of the rudder lever 501 of the rudder hand control 500 is akin to stepping on the left rudder pedal 200a, thereby creating left yaw. Similarly, lifting upward on the rudder grip 503 of the rudder lever 501 of the rudder hand control 500 is akin to stepping on the right rudder pedal 200b, thereby creating right yaw.

Similarly, pushing the rudder grip 503 of rudder hand control 500 down creates a pushing force on the left rudder post 300a and the left rudder pedal 200a in one direction, which may move the right rudder post 300b and the right rudder pedal 200b in the opposite direction. Therefore, pulling the rudder grip 503 of rudder hand control 500 up away from the floorboard 960 may create a pulling action on the left rudder post 300a and cause an input into the right rudder pedal 200b shifting the rudder to the right, which may exert an aerodynamic force on the tail to the left and yaw the nose of the aircraft to the right. Alternatively, pushing the rudder hand grip 503 of rudder hand control 500 down toward the floorboard 960 may create a pushing action on the left rudder pedal 200a and cause an input into the left rudder pedal 200a shifting the rudder to the left, which may exert an aerodynamic force on the tail to the right and yaw the nose of the aircraft to the left. In an embodiment, it is contemplated that the input force required to move rudder hand grip 503 (pull up away from floorboard 960 and push down toward floorboard 960) is about 5-10 pounds. In other embodiments, it is contemplated that the force can be between 3-20 pounds. In further embodiments, it is contemplated that the force can be between 2-30 pounds. Further, in some embodiments, the maximum vertical deflection of rudder hand grip 503 may be about 9 inches (move 4.5 inches up away from floorboard 960 from neutral rudder position and 4.5 inches down toward floorboard 960 from neutral rudder position). In other embodiments, the maximum vertical deflection of rudder hand grip 503 can be between about 6-12 inches. In further embodiments, the maximum vertical deflection of rudder hand grip 503 can be between about 3 and 20 inches. In further embodiments, the maximum vertical deflection of rudder hand grip 503 can be between about 2 and 30 inches. In an embodiment, a top 503a of rudder hand grip 503 can be about 28 inches above the floorboard 960. However, it is contemplated that in some embodiments, top 503a of rudder hand grip 503 can be between 24 and 32 inches above the floorboard 960. However, it is contemplated that in some embodiments, top 503a of rudder hand grip 503 can be between 20 and 36 inches above the floorboard 960. Stated alternatively, in an embodiment, a top 503a of rudder hand grip 503 can be about 28 inches above the floorboard 960 at neutral rudder position. However, it is contemplated that in some embodiments, top 503a of rudder hand grip 503 can be between 24 and 32 inches above the floorboard 960 at neutral rudder position. However, it is contemplated that in some embodiments, top 503a of rudder hand grip 503 can be between 20 and 36 inches above the floorboard 960 at neutral rudder position.

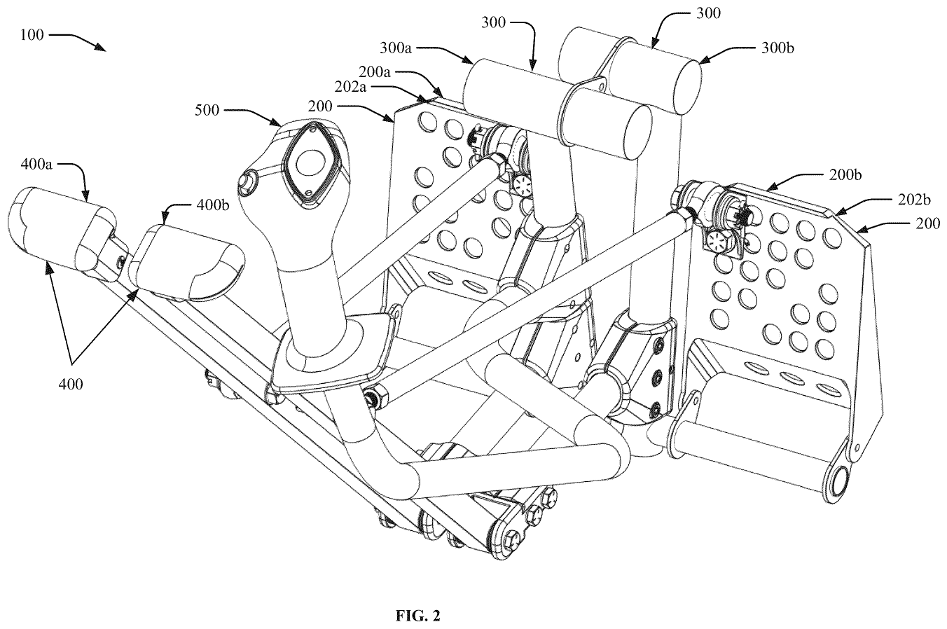

FIG. 2 illustrates a right perspective view of the aircraft hand controls 100 operatively connected to the rudder pedals 200 and the rudder posts 300 for controlling the rudder and brakes of an aircraft. From the right perspective view, the aircraft hand controls 100 may be appreciated for its compact and ergonomic design. The aircraft hand controls 100 may be configured to be centrally located between the left rudder pedal 200a and the right rudder pedal 200b. The left brake hand control 400a and the right brake hand control 400b may be clamped to the left rudder post 300a and the right rudder post 300b, respectively, and be adjacent and parallel with one another.

The ergonomic design of brake hand controls 400 may provide a mechanical advantage requiring light force to control the brakes. The brake hand controls 400 require a gentle push to apply the brakes independently or together. The proximity of the left brake hand control 400a and the right brake hand control 400b may allow for a one-hand brake control while freeing the other hand for other tasks. Similarly, the ergonomic design of the rudder hand control 500 may provide a mechanical advantage requiring light force to control the rudders. The rudder hand control 500 requires a gentle push or pull to adjust the rudder.

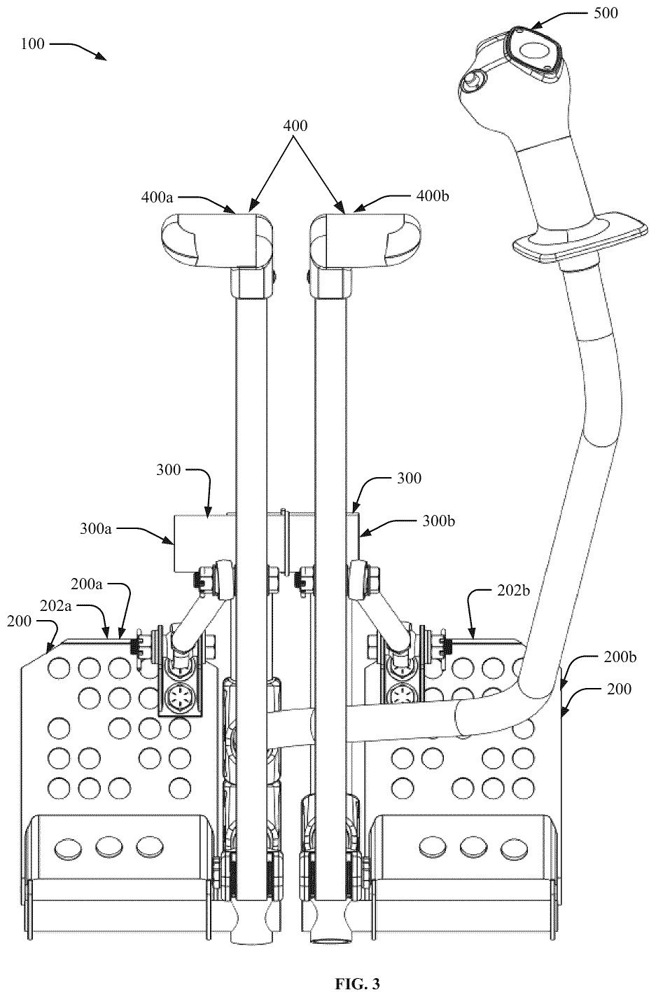

As shown in FIG. 2 as well as FIG. 3, which is a front view of the aircraft hand controls 100 operatively connected to the rudder pedals 200 and the rudder posts 300, the rudder hand control 500 may have a configuration that angle out in the horizontal direction thereby providing a mechanical advantage. As shown in FIG. 3, the brake hand controls 400 may have a configuration that pushes onto the left and right rudder toe brakes 202a and 202b at an angle when the brake hand controls 400 are gently pushed forward thereby providing a mechanical advantage.

As shown in FIG. 3, the brake hand controls 400 may be configured to fit narrowly between the left rudder pedal 200a and the right rudder pedal 200b. The rudder hand control 500 may be configured to extend from between the rudder pedals 200 to just past the right rudder pedal 200b. The aircraft hand controls 100 may be configured to be compact from side to side. FIG. 3 illustrates that the rudder pedals 200 and the rudder posts 300 are adjacent to one another and connected together, and the rudder hand control 500 may still be configured to stay close within the width of the rudder pedals 200.

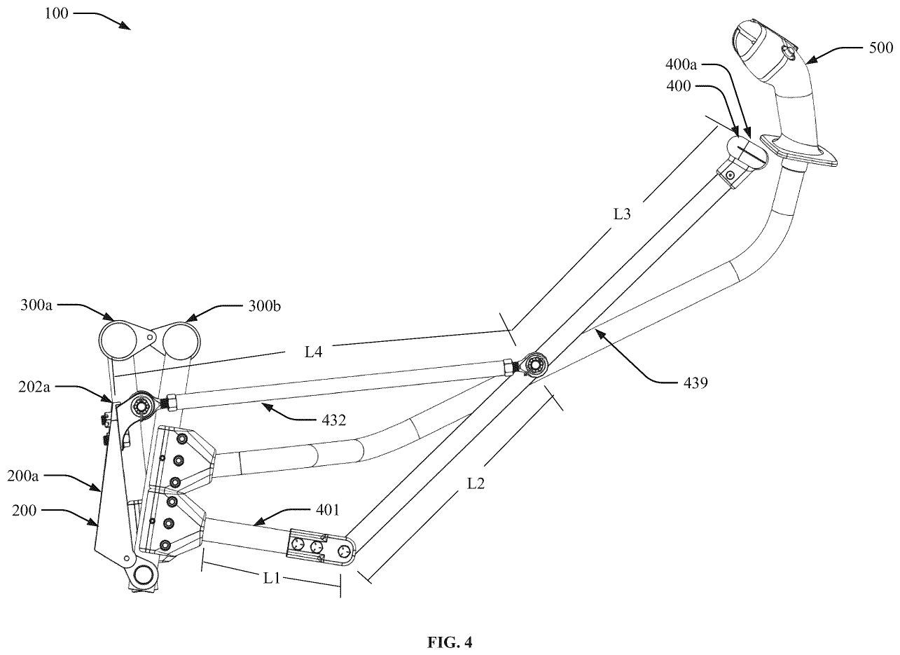

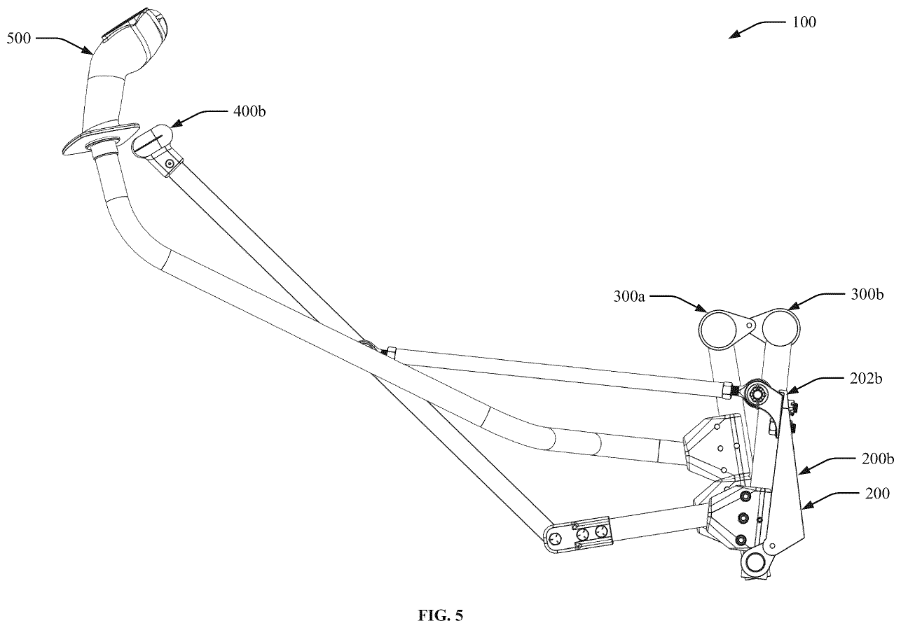

FIGS. 4 and 5 illustrate that the aircraft hand controls 100 may be configured to be compact from back to front. Being that the aircraft hand controls 100 may be configured to be compact, centrally located relative to the rudder pedals 200, the aircraft hand controls 100 do not interfere with the operation of the aircraft from neither the pilot nor copilot position. Even with the aircraft hand controls 100 installed, the rudder pedals 200 and the rudder toe brakes 202 may still be accessible.

FIG. 4 further illustrates the proportional length of the brake hand controls 400. The brake hand controls 400 may comprise brake arm 401, brake push rod 432, and brake lever 439. The brake arm 401 may have a length L1. The brake lever 439 may have a length of L2 plus the length of L3. The brake push rod 432 may have a length of L4. The length of L4 may be greater than the length of L3. The length of L3 may be greater than the length of L2. The length of L2 may be greater than the length of L1. The length of L2 plus the length of L3 may be greater than the length of L4. The length of L2 plus the length of L3 may be greater than the length of L1 plus the length of L4.

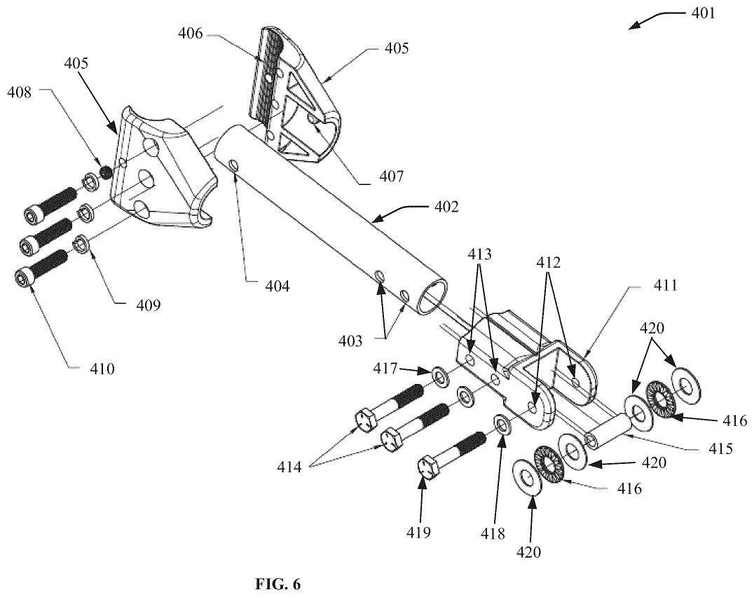

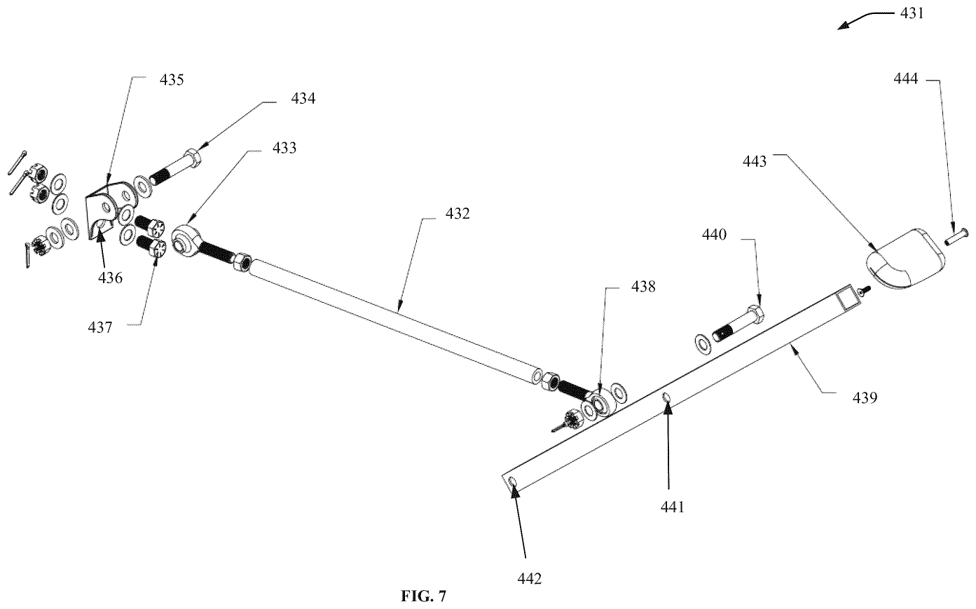

Turning now to FIG. 6, which illustrates an explosive view of a brake arm 401 of the brake hand controls 400. The brake arm 401 may comprise a brake arm tube 402, brake clamp 405, and brake lever hinge 411. The brake clamp 405 may engage with the brake arm tube 402 via hole 404 and boss 407 to eliminate possible slippage. The brake clamp 405 may engage with the brake arm tube 402 via a different engagement mechanism such as other mating protrusions and recesses, connectors, fasteners, or the like. The brake clamp 405 may be clasped together and fastened by fasteners such as, but not limited to, screw 408, lock washers 409, bolts 410, and a threadlocker. The brake clamp 405 may have ridges 406 for gripping onto the rudder posts 300. The brake clamp 405 may engage with the brake arm tube 402 at one end of the brake arm tube 402. At the other end, the brake arm tube 402 may engage with brake lever hinge 411. The brake lever hinge 411 may be fastened to the brake arm tube 402 by a fastener such as, but not limited to, bolts 414 and washers 417. The bolts 414 may bolt the brake lever hinge 411 to the brake arm tube 402 through holes 413 and 403. The brake arm 401 may be operatively connected to brake push lever 431 by a fastener such as, but not limited to, bolt 419, washers 418 and 420, needle roller thrust bearing 416, and bearing sleeve 415. The bolt 419 may operatively connect the brake arm 401 to the brake push lever 431 through holes 412 and 442, as shown in FIG. 7.

Referring to FIG. 7, the brake push lever 431 may comprise brake push rod 432, pedal bracket 435, brake lever 439, and brake lever handle 443. At one end, the brake push rod 432 may be operatively connected to the pedal bracket 435 by fasteners such as, but not limited to, ball joint 433 and bolt 434. Fasteners such as, but not limited to, bolts 437 may be used to fasten the pedal bracket 435 to the rudder pedals 200 through hole 436. At another end, the brake push rod 432 may be operatively connected to the brake lever 439. Fasteners such as, but not limited to, ball joint 438 and bolt 440 may be used to fasten the brake push rod 432 to the brake lever 439 through hole 441. The ball joints 433 and 438 may allow for rotation at respective ends of the brake push rod 432. The brake lever 439 may be operatively connected to the brake arm 401, at one end. At the opposite end, the brake lever 439 may be attached to the brake lever handle 443. Fasteners such as, but not limited to, binding barrel 444 may be used to fasten the brake lever handle 443 to the brake lever 439.

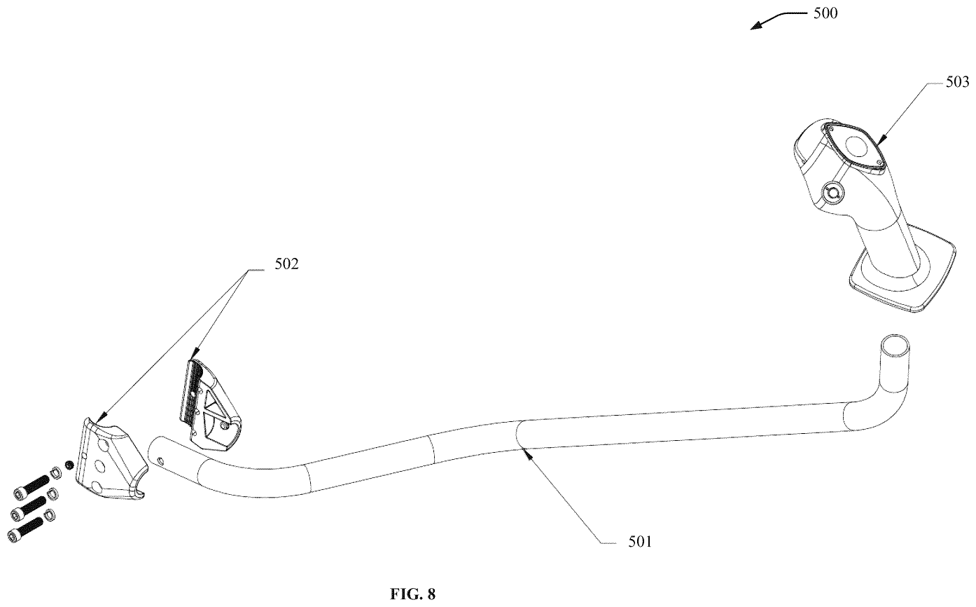

Turning now to FIG. 8, which illustrates an explosive view of the rudder hand control 500. The rudder hand control 500 may comprise rudder lever 501, rudder clamp 502, and rudder grip 503. The rudder clamp 502 may be operatively connected to one end of the rudder lever 501, and the rudder grip 503 may be operatively connected to the other end of the rudder lever 501. The rudder clamp 502 may clamp the rudder hand control 500 onto either the rudder post 300a or the rudder post 300b.

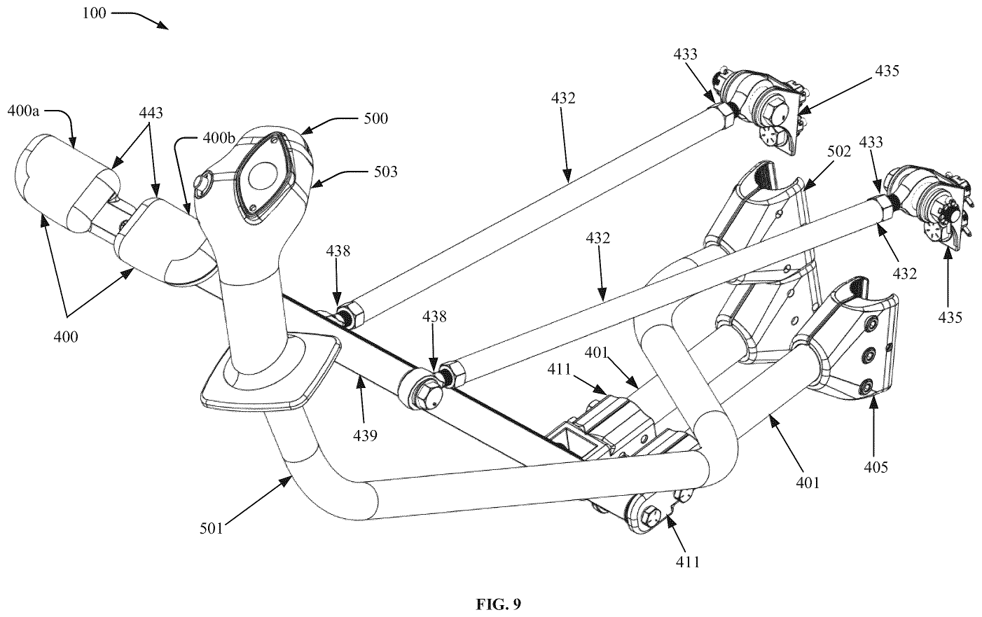

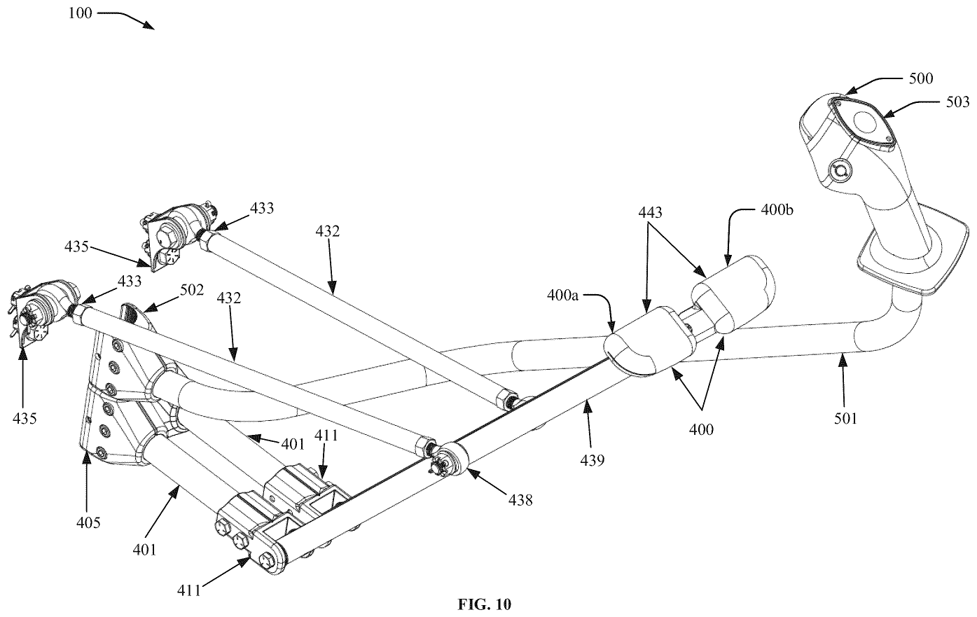

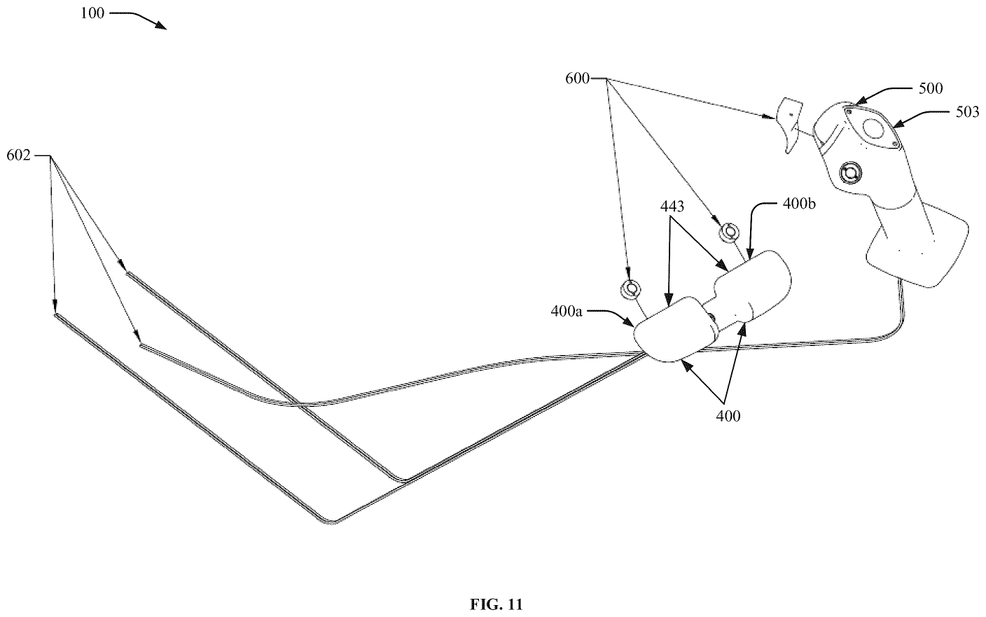

FIGS. 9 and 10 further illustrate the aircraft hand controls 100 from a southeast isometric view and a southwest isometric view, respectively. FIGS. 9 and 10 further illustrate the ergonomic design of the brake hand controls 400. The brake lever 439 may be operatively connected to the brake arm 401 and the brake push rod 432 by the hinge 411 and the ball joints 433 and 438. The hinge 411 and ball joints 433 and 438 may allow the respective connecting points to rotate and pivot, which may allow for precise control of the brakes. Pushing the brake hand controls 400 forward pushes down on the brake push rod 432 to apply the brake. Pushing forward on the brake grip 443 may be a natural motion. In addition, the mechanical advantage of the brake hand controls 400 may also improve.

Likewise, the lifting up or pushing down of the rudder grip 503 may also be a natural motion. Due to the design of the rudder lever 501 having an angle in the horizontal direction, a lifting up or pushing down at the rudder grip 503 may cause a corresponding motion at the rudder clamp 502 and left rudder post 300a. The mechanical advantage of pulling or pushing the rudder grip 503 may also improve.

Keeping with the southwest isometric view, FIG. 11 illustrates an example, non-limiting, embodiment of the aircraft hand controls 100 comprising push-to-talk buttons 600 on the brake grip 443 or rudder grip 503 operatively connected to an aircraft's audio panel 960 via wires 602. By placing the push-to-talk buttons (switches) 600 on the brake grip 443 and/or rudder grip 503, the push-to-talk buttons 600 may be more accessible to the pilot. During takeoff, landing, or while taxiing an aircraft, a pilot is multi-tasking and may need to use the brake hand controls 400 and the rudder hand control 500 often, so it may be useful to place the push-to-talk buttons 600 in the brake lever handle 443 or rudder grip 503.

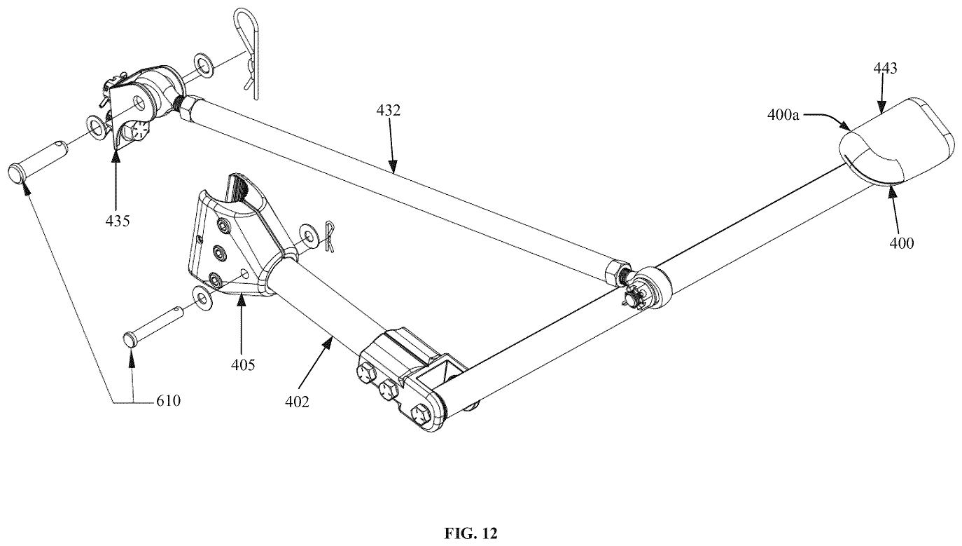

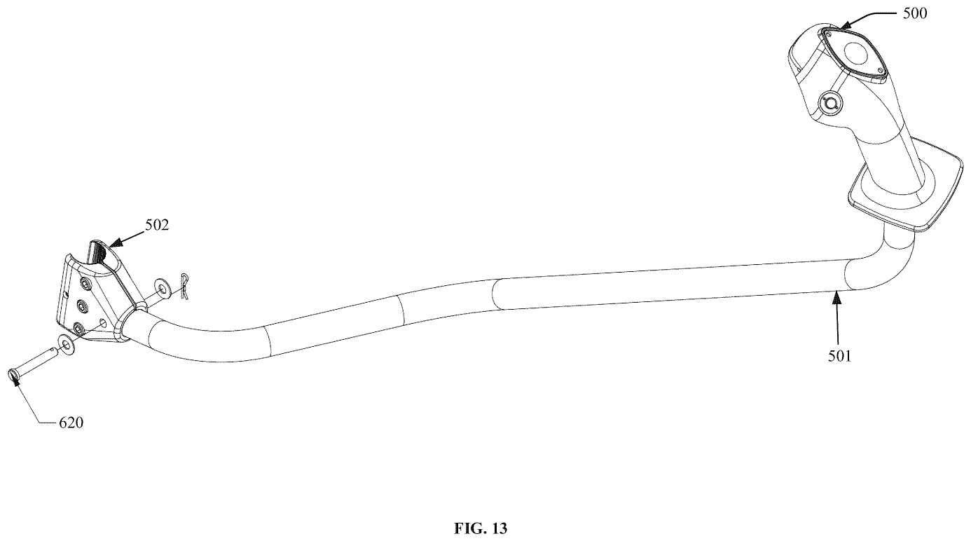

In other embodiments, the brake hand controls 400 may comprise a quick release feature. FIG. 12 illustrates that the left brake hand control 400a, and similarly the right brake hand control 400b, may comprise quick release pins 610 for quickly releasing the pedal bracket 435 from the brake push rod 432 and quickly releasing the brake clamp 405 from the brake arm tube 402. FIG. 13 illustrates that the rudder hand control 500 may comprise quick release pin 620 for quickly releasing the rudder clamp 502 from the rudder lever 501. Although the rudder pedals 200 and the rudder toe brakes 202 may still be accessible with the aircraft hand controls 100 connected, it may still be convenient to have a quick release option to free up space.

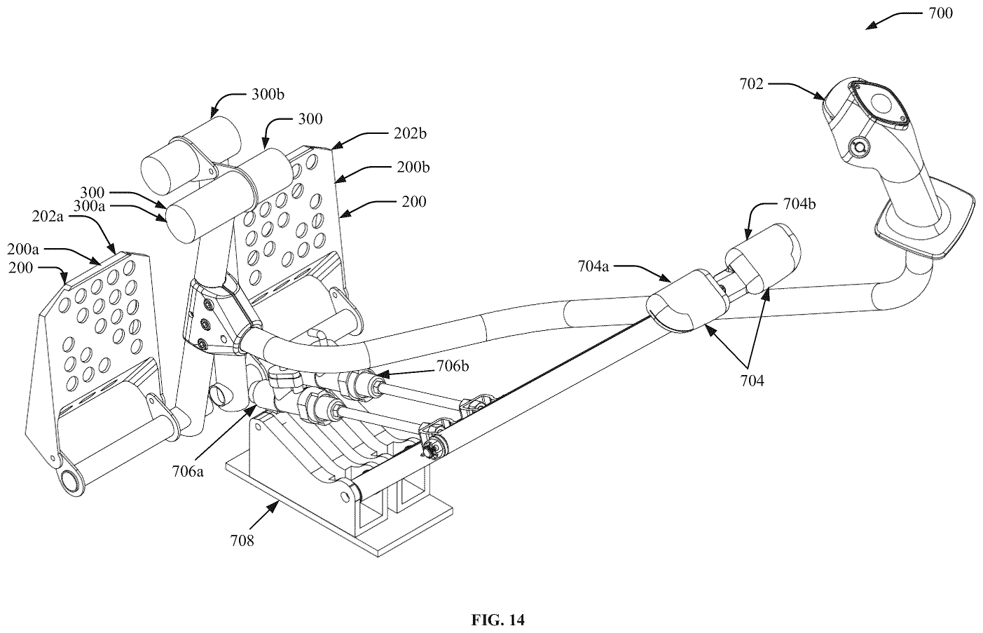

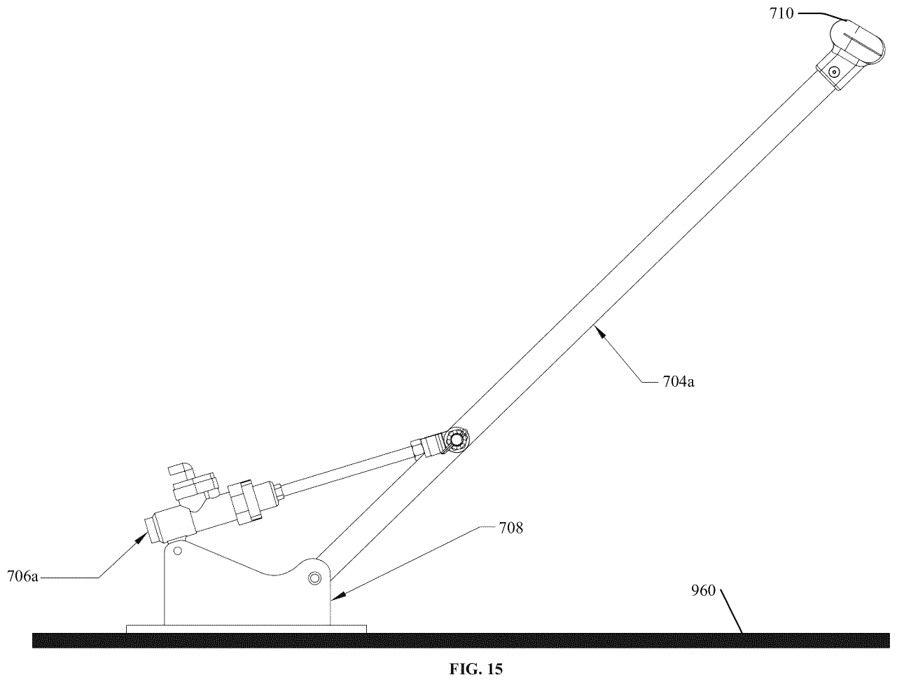

In yet another embodiment, the aircraft hand controls disclosed herein may comprise a hydraulic brake adaptation. As a non-limiting example, FIG. 14 illustrates aircraft hand controls 700 comprising rudder hand control 702, left brake hand control 704a operatively connected to hydraulic master cylinder 706a, right brake hand control 704b operatively connected to hydraulic master cylinder 706b, and brake hand controls 704 may be attached to the aircraft's floor with bracket 708. The rudder hand control 702 may be operatively connected to the left rudder post 300a. However, the rudder hand control 702 may also be operatively connected to the right rudder post 300b. The pressure exerted from pushing the left brake hand control 704a may be converted to hydraulic pressure and plumbed into the aircraft's hydraulic braking 905 system by the left brake hydraulic master cylinder 706a. The pressure exerted from pushing the right brake hand control 704b may be converted to hydraulic pressure and plumbed directly into the aircraft's hydraulic braking system 905 by the right brake hydraulic master cylinder 706b. With this example hydraulic brake adaptation, the brake hand controls 704 may not need to be connected to the rudder pedals 200 or the rudder posts 300, but will receive the same inputs from the pilot 925.

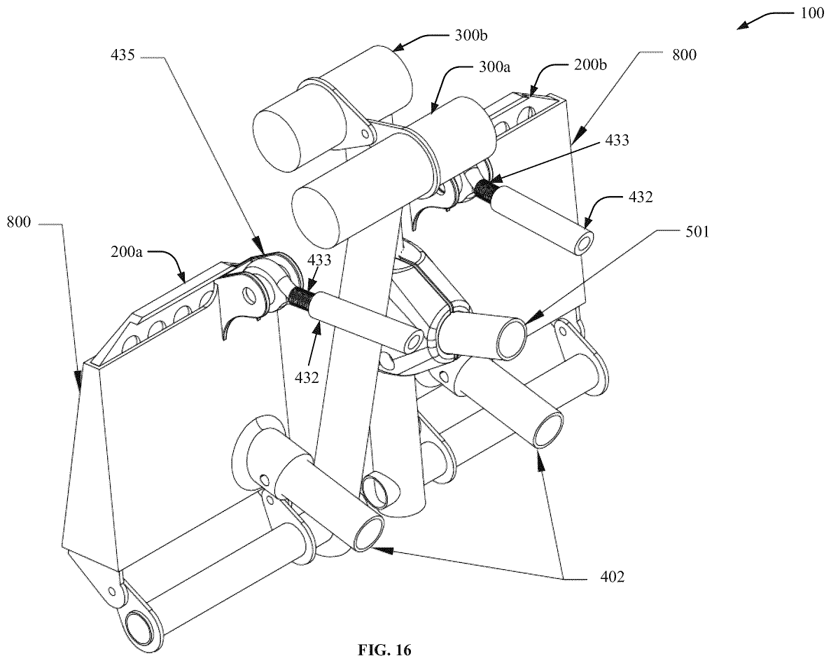

FIG. 15 illustrates a left view of the left brake hand control 704a operatively connected to hydraulic master cylinder 706a and attached to the aircraft's floorboard 960 with bracket 708. Although not shown, the right brake hand control 704b may have a similar configuration. The left brake hand control 704b may be operatively connected to hydraulic master cylinder 706b and attached to the aircraft's floor with the bracket 708. The mechanics of using the left brake hand control 704a may remain similar to other versions without a hydraulic brake adaptation. That is, a push on the left brake hand control 704a also pivots it forward and apply the left brake. Similarly, a push on the right brake hand control 704b also pivots it forward and apply the right brake.

In another embodiment, an attachment variation may be provided. An attachment variation may include using attachment plates. FIGS. 16-18 illustrate the aircraft hand controls 100 operatively connected to left rudder pedal 200a and right rudder pedal 200b using rudder pedal attachment plate 800. FIG. 16 is a southwest isometric view illustrating that the brake push rod 432 and the brake arm tube 402 may be operatively connected to the rudder pedal attachment plate 800. The brake push rod 432 may be operatively connected to the rudder pedal attachment plate 800 with the pedal bracket 435 and the ball joint 433. In this example, non-limiting, embodiment, the rudder lever 501 may be operatively connected to the right rudder post 300b. However, the rudder lever 501 may also be operatively connected to the left rudder post 300a.

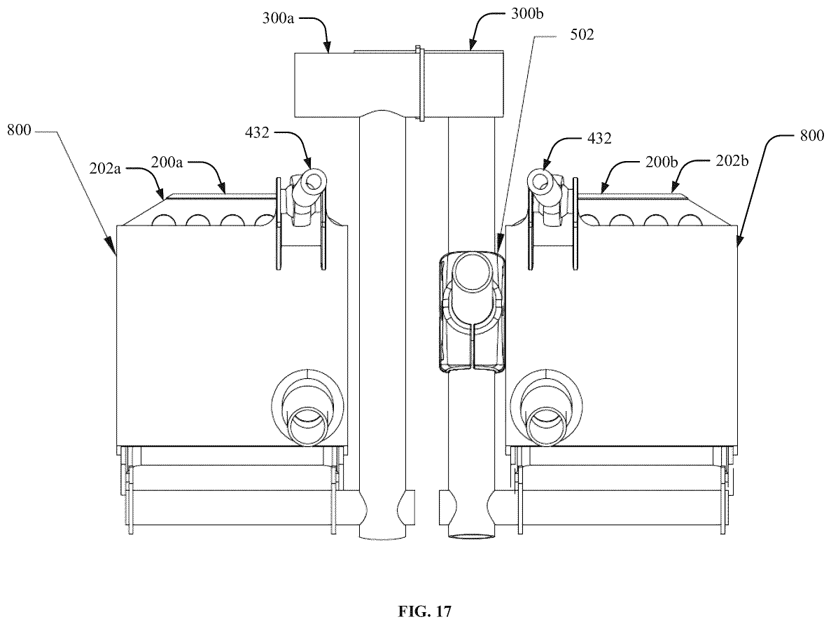

FIG. 17 is a front view illustrating the attachment of the rudder pedal attachment plate 800 on the left rudder pedal 200a and the right rudder pedal 200b. The brake push rod 432 may be operatively located at the rudder toe brakes 202a and 202b.

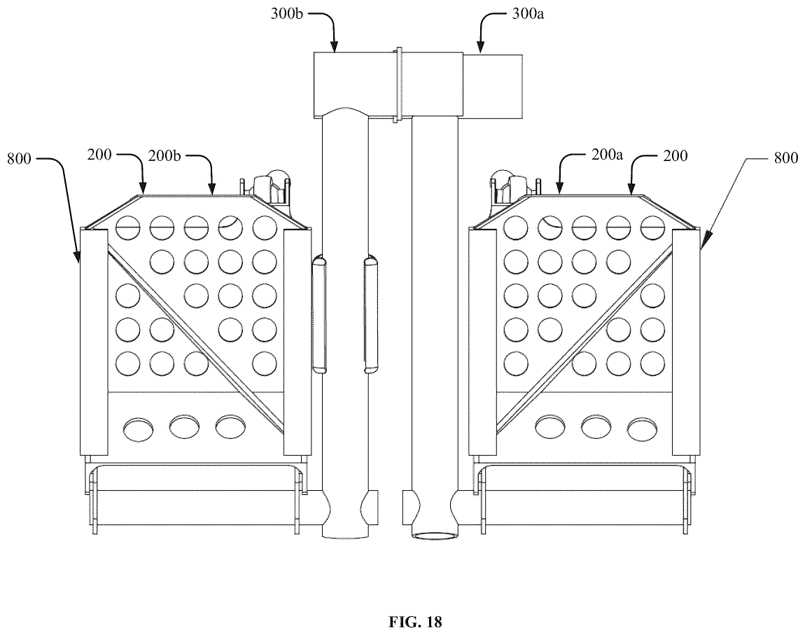

FIG. 18 illustrates a rear view of the attachment of the rudder pedal attachment plate 800. The rudder pedal attachment plate 800 may be folded over to create a grip on both the right and left side of the rudder pedals 200. In this embodiment, the brake hand controls 400 may be easily connected to the rudder pedals 200 by sliding the rudder pedal attachment plate 800 down over the rudder pedals 200 if the brake hand controls 400 are already attached to the rudder pedal attachment plate 800. To disconnect the brake hand controls 400 from the rudder pedals 200, slide the rudder pedal attachment plate 800 up with the brake hand controls 400 still connected to the rudder pedal attachment plate 800.

TABLE 1.0
Taxi and Takeoff Procedure by Phase of Flight-

| Flight Phase | Left Hand | Right Hand | Description of Task |
|---|---|---|---|
| 1- Ground Taxi | Left hand brake grip | Right hand brake | Ground taxi from ramp |
| | 443a and Push to talk | grip 443b and | to runway. Requires |
| | switch 600 as | push-to-talk | differential steering |
| | required | switch 600 as | while communicating |
| | | required | with Ground and |
| | | | Tower controllers |
| 2 - Spool up | Both left hand brake | Power Lever | While applying full |
| | grip 443a and right | (throttle) 955 - | brakes, increase power |
| | hand brake grip 443b | Increase Power | to full power and allow |
| | applying full brake | | engine to spool up |
| | power | | |
| 3 - Brake Release | Both left hand brake | Power lever | Initial Brake release - |
| | grip 443a and right | (throttle) 955 - Set | aircraft begins takeoff |
| | hand brake grip | max power | roll |
| | 443b - release brake | | |
| 4 - Initial Ground | Left hand brake grip | Right hand brake | Maintain runway |
| Roll | 443a | grip 443b | centerline using |
| | | | differential braking |
| 5 - Transition | Side Stick 960 (Pitch | Rudder grip 503 to | Aircraft has reached an |
| | and Roll Control) | control steering | airspeed adequate to |
| | | | allow rudder authority |
| | | | for steering and |
| | | | maintaining runway |
| | | | centerline. As airspeed |
| | | | rapidly increases, pilot |
| | | | prepares to rotate and |
| | | | lift off (side stick 960) |
| | | | or reduce power |
| | | | (throttle 955) and |
| | | | rapidly brake using left |
| | | | hand brake grip 443a |
| | | | and right hand brake |
| | | | grip 443b (rejected |
| | | | take off) |
| 6 - Rotate | Side Stick 960 | Rudder grip 960 | Rotation from ground |
| | | | to flight. Side stick 960 |
| | | | controls pitch and roll, |
| | | | Rudder grip 503 |
| | | | controls yaw |
| 7 - Climb out | Side Stick 960 | Power Lever | Left hand is controlling |
| | | (throttle 955), | pitch and roll with side |
| | | Radios (push-to- | stick 960, Right hand is |
| | | talk switch 600) | available to adjust |
| | | and Auto | rudder trim (rudder |
| | | Pilot/Flight | grip 503), power |
| | | Management | setting (throttle 955), |
| | | System (FMS) | radios (push-to-talk |
| | | | switch 600), auto pilot |
| | | | and FMS |

The table below describes the tasks associated with the various phases of ground taxi, and take off. It also describes which tasks the pilot's left or right hands are performing respectively.

TABLE 1.1
Landing and Taxi Procedure by Phase of Flight-

| Flight Phase | Left Hand | Right Hand | Description |
|---|---|---|---|
| 1 - Final Approach | Side Stick 960 | Power Lever | Final Approach course |
| to Landing | | (throttle) 955 | of flight. Pilot uses left |
| | | | hand to control the |
| | | | pitch and roll of the |
| | | | aircraft using side stick |
| | | | 960 and the right hand |
| | | | to adjust to power lever |
| | | | 955. Together the pitch |
| | | | and power control the |
| | | | critical approach speed. |
| 2 - Flare/Round-Out- | Side Stick 960 | Power lever | Immediately prior to |
| (immediately prior | | (throttle) 955 then | touchdown, the pilot |
| to main gear | | immediately to | pulls power to idle |
| contacting the | | rudder grip 503 | using throttle 955 and |
| runway) | | | then immediately the |
| | | | right hand goes from |
| | | | the power lever 955 to |
| | | | the rudder grip 503 to |
| | | | control yaw so that |
| | | | aircraft touches down |
| | | | in the yaw direction |
| | | | aligned with the |
| | | | runway. |
| 3 - High Speed Roll | Side Stick 960 | Rudder grip 503 - | Once touchdown has |
| Out | | push-to-talk | occurred, and during |
| | | switch 600 as | the high speed roll out, |
| | | required | the right hand must be |
| | | | used to control the |
| | | | rudder grip 503 and |
| | | | maintain directional |
| | | | control down the |
| | | | runway. The push-to- |
| | | | talk switch 600 is |
| | | | available for |
| | | | communication with |
| | | | Tower and Ground |
| | | | Control |
| 4 - High Speed | Side Stick 960 | Both left hand | Pilot must use the right |
| Braking | | brake grip 443a | hand to pull back on the |
| | | and right hand | side stick 960 (pitching |
| | | brake grip 443b | the nose up and adding |
| | | | more weight to the |
| | | | landing gear) while the |
| | | | left hand must apply |
| | | | braking power to slow |
| | | | and differential braking |
| | | | power can be exerted |
| | | | by rotating the wrist to |
| | | | maintain directional |
| | | | control during the |
| | | | deceleration. using both |
| | | | left hand brake grip |
| | | | 443a and right hand |
| | | | brake grip 443b |
| 5 - Low Speed Roll | Left hand brake grip | Right hand brake | When the aircraft has |
| Out | 443a | grip 443b | substantially slowed |
| | | | where the wing no |
| | | | longer has the energy to |
| | | | create lift, directional |
| | | | control and steering off |
| | | | the runway can be |
| | | | managed using the left |
| | | | hand brake grip 443a |
| | | | and right hand brake |
| | | | grip |
| | | | 443bindependently. |
| | | | Push-to-talk switches |
| | | | 600are available as |
| | | | needed for |
| | | | communication with |
| | | | Tower and Ground |
| | | | Controllers. |

The table below describes the tasks associated with the various phases of Landing and Ground Taxi. It also describes which tasks the Pilot's left or Right hands are performing respectively.

TABLE 1.2
Ground Taxi Procedure-

| | | | |
|---|---|---|---|
| 1 - Steering | Left hand brake | Right hand brake | Apply differential |
| | grip 443a | grip 443b | braking to control |
| | | | direction of aircraft |
| | | | and/or apply full |
| | | | brakes to come to a |
| | | | complete stop using |
| | | | left hand brake grip |
| | | | 443a and right hand |
| | | | brake grip 443b |
| 2 - | Both left hand | Power Lever | Adjust throttle 955 to |
| Accelerating/Decelerating | brake grip 443a and | (throttle) 955 | control speed of |
| | right hand brake | | aircraft in |
| | grip 443b | | conjunction with left |
| | | | hand brake grip 443a |
| | | | and right hand brake |
| | | | grip 443b |
| 3 - Steering and | Left hand brake | Right hand brake | Pilot can speak over |
| communicating | grip 443a and | grip 443b and | radio using push to |
| | push-to-talk | push-to-talk | talk buttons 600 on |
| | switch 600 | switch 600 | hand breke grips |
| | | | 443a 443b to |
| | | | communicate with |
| | | | ground control/ATC. |

The table below describes the tasks associated with the various phases of Ground Taxi. It also describes which tasks the pilot's left or right hands are performing respectively.

As can be seen, the pilot has to juggle multiple controls, such as the throttles 995, rudder grip 503, right hand brake grip 443b, left hand brake grip 443a, and sidestick 960. These hand controls 100 with differential braking and push to talk help to make that possible.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. Aircraft hand controls, comprising:
a left brake hand control adapted to connect to and control a left toe brake;
a right brake hand control adapted to connect to and control a right toe brake; and
a rudder hand control adapted to connect to and move a rudder post.

2. The aircraft hand controls of claim 1, wherein the left brake hand control and the right brake hand control comprises a brake lever, a brake push rod, and a brake arm.

3. The aircraft hand controls of claim 2, wherein a length of the brake lever is greater than a length of the brake arm and the brake push rod combined.

4. The aircraft hand controls of claim 2, wherein the brake lever, the brake push rod, and the brake arm are joined by a connection mechanism that rotates or pivots.

5. The aircraft hand controls of claim 4, wherein the connection mechanism is a hinge or a ball joint.

6. The aircraft hand controls of claim 1, wherein the rudder hand control comprises a lever arm that angles out in a horizontal direction.

7. The aircraft hand controls of claim 1, wherein the left brake hand control, the right brake hand control, and the rudder hand control comprises clamps and brackets.

8. The aircraft hand controls of claim 7, wherein the clamps and brackets further comprises pins for quick release of the clamps and the brackets.

9. The aircraft hand controls of claim 1, further comprising attachment plates for the attachment of the left brake hand control and the right brake hand control.

10. The aircraft hand controls of claim 9, wherein each attachment plate fits over one or more rudder pedals.

11. Brake hand controls, comprising:
a left brake hand control for exerting pressure on a left brake;
a right brake hand control for exerting pressure on a right brake; and
a set of hydraulic master cylinders that convert the exerted pressure into hydraulic pressure.

12. The brake hand control of claim 11, wherein the set of hydraulic master cylinders plumb the hydraulic pressure into an aircraft's hydraulic break system.

13. The brake hand control of claim 11, wherein the set of hydraulic master cylinders plumb the hydraulic pressure into a right hydraulic brake or a left hydraulic brake based on whether the exerted pressure comes from the left brake hand control or the right brake hand control.

14. Aircraft hand controls, comprising:
a left brake hand control and a right brake hand control adapted to control a left toe brake and a right toe brake;
a rudder hand control adapted to control a set of rudder pedals; and
one or more push-to-talk buttons turn on a push-to-talk feature connected to an audio panel.

15. The aircraft hand controls of claim 14, wherein the one or more push-to-talk buttons are on the left brake hand control, the right brake hand control, or the rudder hand control.

16. The aircraft hand controls of claim 14, wherein the one or more push-to-talk buttons are on a left hand brake grip of the left brake hand control, a right hand brake grip of the right brake hand control, or a rudder grip of the rudder hand control.

17. The aircraft hand controls of claim 14, wherein the left brake hand control and the right brake hand control comprises a brake lever, a brake push rod, and a brake arm.

18. The aircraft hand controls of claim 17, wherein a length of the brake lever is greater than a length of the brake arm and the brake push rod combined.

19. The aircraft hand controls of claim 17, wherein the brake lever, the brake push rod, and the brake arm are joined by a connection mechanism that rotates or pivots.

20. The aircraft hand controls of claim 14, wherein the rudder hand control comprises a lever arm that angles out in a horizontal direction.
